(19) United States
(12) Patent Application Publication
(10) Pub. No.: US 2016/0112454 A1
(43) Pub. Date: Apr. 21, 2016

(54) ELECTRONIC DEVICE AND METHOD FOR DATA COMMUNICATION

(71) Applicant: Samsung Electronics Co., Ltd., Gyeonggi-do (KR)

(72) Inventors: Kyunghee LEE, Gyeonggi-do (KR); Ignat KORCHAGIN, Gyeonggi-do (KR); Tymur KORKISHKO, Gyeonggi-do (KR); Siejoon CHO, Seoul (KR)

(21) Appl. No.: 14/887,655

(22) Filed: Oct. 20, 2015

(30) Foreign Application Priority Data
Oct. 20, 2014 (KR) 10-2014-0141545

(51) Int. Cl. H04L 29/06; G06F 21/60

(52) U.S. Cl. CPC H04L 63/20; G06F 21/606

(57) ABSTRACT

Disclosed herein is an electronic device and method for data communication. The electronic device includes a communication unit for communicating with a counterpart device through a communication network, and at least one processor, which may execute the method, including negotiating via the communication unit with the counterpart device for a security layer to perform security processing of data, determining at least one layer as the security layer based on a result of the negotiation outcome, and communicating with the counterpart device using the security layer.

### CLAIM OF PRIORITY

This application claims priority from and the benefit under 35 U.S.C. §119(a) of Korean Patent Application No. 10-2014-0141545, filed on Oct. 20, 2014, which is hereby incorporated by reference for all purposes as if fully set forth herein.

### TECHNICAL FIELD

The present disclosure relates generally to an electronic device having a security communication function and a method of allowing an electronic device to communicate with an external device through the function.

### BACKGROUND

Communication networks have layered architectures, where each layer is responsible for data transfer. Communication networks may follow a general pattern such as an Open Systems Interconnection (or “OSI”) model. In the OSI model, each layer has the same data format. According to the data format, each piece of binary data (such as, for example, a packet or a frame) may include a header and a payload.

The header may include layer-specific information and metadata on a corresponding layer to process data. The metadata is utilized to accurately process the payload by the corresponding layer. For example, the payload of a highest layer includes application data. Any layer transfers data including a payload (that is, including a header and a payload of a higher layer) and a header thereof to a lower layer. For example, the payload of the highest layer may include application data.

### SUMMARY

A user device may process security of data (such as, for example, process ciphering or integrity checking) in any layer according to the OSI model and transmit the processed data to a counterpart device. For example, an application layer may process security of application data (such as voice data).

Any layer (such as a transport layer or a network layer) lower than the application layer may perform security processing of a payload. Then, not only the application data but also a header (e.g., metadata) corresponding to a higher layer is also security-processed. However, the counterpart device may not process (e.g., decipher the ciphered metadata) the security-processed data in the same layer and, accordingly, may not accurately operate on the application data. For example, as a result, an inaccurate or distorted user voice may be output through a speaker of the counterpart device. Further, a connection between two devices may be interrupted or disconnected entirely.

In view of the foregoing, an aspect of the present disclosure is to provide a method of allowing communication with the counterpart device by dynamically (i.e., selectively) setting a layer to perform security processing, and an electronic device for implementing the same.

In accordance with an aspect of the present disclosure, a method of communicating data by an electronic device, including negotiating with a counterpart device for a security layer to perform security processing of data, determining at least one layer as the security layer based on the negotiation outcome, and communicating with the counterpart device using the security layer.

In accordance with another aspect of the present disclosure, an electronic device is disclosed, including a communication unit for communicating with a counterpart device through a communication network, and at least one processor configured to negotiate via the communication unit with the counterpart device for a security layer to perform security processing of data, determine at least one layer as the security layer based on the negotiation outcome, and communicate with the counterpart device using the security layer.

In accordance with another aspect of the present disclosure, a non-transitory computer-readable recording medium having commands stored therein, the commands are configured to allow one or more processors to perform one or more operations when executed by the one or more processors, the one or more operations including negotiating with a counterpart device for a security layer to perform security processing of data, determining at least one of the layers as the security layer based on the negotiation outcome, and communicating with the counterpart device by using the security layer.

The present disclosure provides a method of allowing communication with a counterpart device by dynamically and/or selectively setting a layer to perform security processing, and an electronic device for implementing the same.

### BRIEF DESCRIPTION OF THE DRAWINGS

The present disclosure will be more apparent from the following detailed description in conjunction with the accompanying drawings, in which:

FIG. 1 is a block diagram illustrating a configuration of an electronic device according to an example embodiment of the present disclosure;

FIG. 2 is a block diagram illustrating a configuration of a communication unit according to various embodiments of the present disclosure;

FIG. 3 is a flowchart illustrating a communication method according to v embodiment of the present disclosure;

FIG. 4 is a flowchart illustrating a method of dynamically setting a security layer according to an embodiment of the present disclosure;

FIG. 5 is a flowchart illustrating a method of dynamically setting a security layer according to another embodiment of the present disclosure;

FIG. 6 is a flowchart illustrating a communication method according to another embodiment of the present disclosure; and

FIG. 7 is a flowchart illustrating a communication method according to another embodiment of the present disclosure.

### DETAILED DESCRIPTION

Hereinafter, various embodiments of the present disclosure will be described in connection with the accompanying drawings. The present disclosure may be modified in various forms and include various embodiments, but specific examples are illustrated in the drawings and described in the description. However, the description is not intended to limit the present disclosure to the specific embodiments, and it shall be appreciated that all the changes, equivalents and substitutions belonging to the idea of the present disclosure are included in the present disclosure. In describing the drawings, similar reference numerals are used to designate similar elements.

The term “include” or “may include” refers to the existence of a corresponding disclosed function, operation or component which can be used in various embodiments of the present disclosure and does not limit one or more additional functions, operations, or components. In the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

As used herein, the expressions such as “first”, “second”, or the like may modify various elements in various embodiments, but do not limit corresponding elements. For example, the above expressions do not limit the sequence and/or importance of the elements. The above expressions are used merely for the purpose of distinguishing an element from the other elements. For example, without departing from the present disclosure, a first component element may be named a second component element. Similarly, the second component element also may be named the first component element.

The terms in various embodiments of the present disclosure are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to various embodiments of the present disclosure has a security communication function. For example, the electronic device may include at least one of a smart phone, a tablet Personal Computer (PC), a mobile phone, a video phone, an e-book reader, a desktop PC, a laptop PC, a netbook computer, a PDA, a Portable Multimedia Player (PMP), an MP3 player, a mobile medical device, a camera, a wearable device (for example, a Head-Mounted-Device (HMD) such as electronic glasses, electronic clothes, an electronic bracelet, an electronic necklace, an electronic appcessory, an electronic tattoo, or a smart watch.

According to some embodiments, the electronic device may be a smart home appliance with a communication function. The smart home appliances may include at least one of, for example, televisions, digital video disk (DVD) players, audio players, refrigerators, air conditioners, cleaners, ovens, microwaves, washing machines, air purifiers, set-top boxes, TV boxes (e.g., HomeSync™ of Samsung, Apple TV™, or Google TV™), game consoles, electronic dictionaries, electronic keys, camcorders, or electronic frames.

According to some embodiments, the electronic device may include at least one of various medical devices {e.g., a magnetic resonance angiography (MRA), a magnetic resonance imaging (MRI), a computed tomography (CT) machine, and an ultrasonic machine}, navigation devices, global positioning system (GPS) receivers, event data recorders (EDR), flight data recorders (FDR), vehicle infotainment devices, electronic devices for ships (e.g., navigation devices for ships, and gyro-compasses), avionics, security devices, automotive head units, robots for home or industry, automatic teller's machines (ATMs) in banks, or point of sales (POS) in shops.

According to some embodiments, the electronic device may include at least one of furniture or a part of a building/structure, an electronic board, an electronic signature receiving device, a projector, or various types of measuring devices (for example, a water meter, an electric meter, a gas meter, a radio wave meter and the like) including a camera function. An electronic device according to various embodiments of the present disclosure may be a combination of one or more of above described various devices. Also, an electronic device according to various embodiments of the present disclosure may be a flexible device. Also, an electronic device according to various embodiments of the present disclosure is not limited to the above described devices.

The term “screen” used in various embodiments may refer to a screen of a display unit. For example, the term “screen” in the phrase “an image is displayed on a screen”, “a display unit displays an image on a screen,” or “a controller controls a display unit to display an image on a screen” may be used as “a screen of a display unit.” Further, the term “screen” may refer to a target to be displayed on a display unit. For example, the term “lock screen” in the phrase “a lock screen is displayed,” “a display unit displays a lock screen,” or “a controller controls a display unit to display a lock screen” may be used as a target to be displayed.

In various embodiments, an external device and a counterpart device correspond to electronic devices having a security communication function. The terms “external” and “counterpart” refer to other electronic devices from a viewpoint of one electronic device, and it should be understood that the terms “external” and “counterpart” do not limit functions or operations of the corresponding devices.

Hereinafter, an electronic device according to various embodiments and a method implemented by the electronic device will be described with reference to the accompanying drawings.

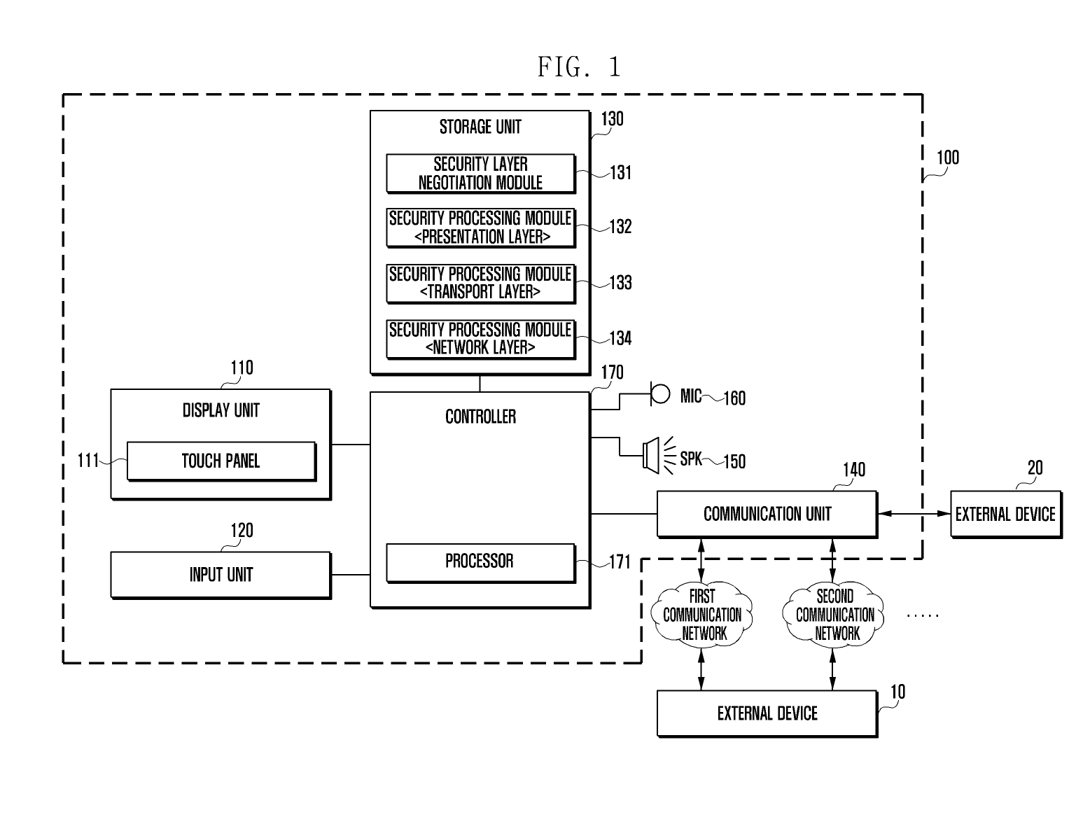

FIG. 1 is a block diagram illustrating a configuration of an electronic device according to various embodiments of the present disclosure. Referring to FIG. 1, an electronic device 100 according to various embodiments of the present disclosure may include a display unit 110, an input unit 120, a storage unit 130, a communication unit 140, a speaker 150, a microphone 160, and a controller 170. The display unit 110 may display various pieces of information under a control of the controller 170. The display unit 110 may include a display panel or a hologram. For example, the display panel may be a Liquid Crystal Display (LCD), an Active Matrix Organic Light Emitting Diode (AM-OLED), or the like. The display panel may be implemented to be, for example, flexible, transparent, or wearable. The hologram may show a three-dimensional image in the air using interference of light. The display unit 110 may further include a control circuit for controlling the display panel or the hologram.

The display panel may include a touch panel 111 implementing an input unit for facilitating interaction between the user and the electronic device 100. Then, the display unit 110 may be interchangeable with a touch screen.

The touch panel 111 may be implemented in an add-on type in which the touch panel 111 is located on the screen of the display unit 110, or an on-cell type or an in-cell type in which the touch panel 111 is inserted into the display unit 110. The touch panel 111 may detect a user input in at least one of, for example, a capacitive type, resistive type, an infrared type, or an ultrasonic wave type, generate an event corresponding to the user input, and transfer the generated event to the controller 170.

The touch panel 111 may detect a gesture of a conductive object (for example, a finger or a stylus) which directly contacts the screen or is proximate or hovering within a predetermined range in which the touch panel 111 can detect the object. The touch panel 111 may generate an event corresponding to the gesture and transfer the generated event to the controller 170.

The input unit 120 may include, for example, a touch key which is different from the touch panel 111 installed in the display unit 110. The touch key may recognize a touch or proximity of a human body and an object. The input unit 120 may generate an event in response to a user input and transfer the generated event to the controller 170. The input unit 120 may further include a key (for example, a dome key) in one type different from the touch type. For example, when the user presses the dome key, the dome key is transformed to contact a printed circuit board and, accordingly, a key event is generated on the printed circuit board and transmitted to the controller 170.

The storage unit 130 may store data such as SMS, MMS, SNS message, and email data, as generated by the electronic device 100 or received from an external device through the communication unit 140 under a control of the controller 170. The storage unit 130 may store a booting program, at least one operating system, and any installed applications. Further, the storage unit 130 stores various pieces of user settings and/or configuration information (such as screen brightness or the like) for controlling and optimizing a user environment of the electronic device 100. Accordingly, the controller 170 may operate the electronic device 100 with reference to the setting/configuration information.

The storage unit 130 may include a main memory and a secondary memory. The main memory may be implemented by, for example, a Random Access Memory (RAM). The secondary memory may be implemented by a disc, a RAM, a Read Only Memory (ROM), or a flash memory. The main memory may store various programs, for example, a booting program, an operating system (such as, for example, a kernel), middleware, an Application Programming Interface (API), and an application, loaded from the secondary memory. When electrical power is supplied to the controller 170, the booting program may be first loaded to the main memory. The booting program may load the operating system to the main memory. The operating system may load the application to the main memory. The controller 170 may access the main memory to decipher a command (routine) of a program, and execute a function according to a result of the deciphering.

The storage unit 130 may further include an external memory. For example, the storage unit 130 may include Compact Flash (CF), Secure Digital (SD), Micro-Secure Digital (Micro-SD), Mini-Secure Digital (mini-SD), extreme Digital (xD), or a memory stick, as the external memory.

The storage unit 130 may store a security layer negotiation module 131. The security layer negotiation module 131 may be configured to allow the electronic device 100 to perform a function of negotiating with a counterpart device about a device to perform security processing of data and determining the device. The negotiation may be defined as a process for matching layers (hereinafter, referred to as a “security layer”), which perform the security processing, between devices.

The storage unit 130 may store at least one security processing module 132-134. The security processing module 132-134 serves to perform security processing of at least one layer. For example, security processing modules 132, 133, and 134 shown in FIG. 1 each manage a presentation layer, a transport layer, and a network layer, respectively.

Any component of the electronic device 100, such as the processor 171 may perform security processing of data by using the security processing module corresponding to the security layer. For example, when the layer determined as the security layer corresponds to the presentation layer, the processor may perform security processing (such as ciphering) of data ciphered by a codec (such as Adaptive MultiRate or “AMR”) using the security processing module 132.

When the layer determined as the security layer corresponds to the transport layer, the processor may perform security processing (such ciphering, authentication, and integrity checking) of data using the security processing module 133, which may be for example, a Secure Real-Time Transport Protocol (“SRTP”) or Transport Layer Security (“TLS”). When the layer determined as the security layer corresponds to the network layer, the processor may perform security processing, such as, ciphering and authentication checking of data, using the security processing module 134 (e.g., Internet Protocol security or “IPsec”). Meanwhile, a security processing module, which manages another layer (e.g., an application layer) as well as the above described layers, may be further stored in the storage unit 130.

The communication unit 140 may perform data communication (e.g., a voice call, a video call, an SMS, or an Internet service) with an external device 10 through a communication network (e.g., LTE, wireless LAN, or the like) under a control of the controller 170. The communication unit 140 may directly perform the data communication with an external device 20 through a designated frequency channel without a relay of the network (e.g., without a relay of an Access Point or “AP”).

The speaker 150 converts the audio signal received from the controller 170 into a sound wave and outputs the sound wave. The microphone 160 may convert sound waves transferred from the person or other sound sources into audio signals and output the audio signals to the controller 170.

The controller 170 controls general operations of the electronic device 100 and a signal flow between internal components of the electronic device 100, process data, and controls power supply to the components from the battery.

The controller 170 may include a processor 171. The processor 171 may include an Application Processor (AP), a Communication Processor (CP), a Graphic Processing Unit (CPU), and an audio processor. The CP may be a component of the communication unit 140.

The processor 171 (e.g., the AP) may load a command or data received from a non-volatile memory (e.g., a memory used as the secondary memory) or another component connected to the processor 171 or at least one of the other components to a volatile memory (e.g., a memory used as the main memory) and process the loaded command and data. Further, the processor 171 may store data received from or generated by at least one of other components in the non-volatile memory.

The processor 171 (e.g., the AP) may dynamically set a security layer by using the security layer negotiation module 131 and implement a method of performing security processing of the data in the security layer. Hereinafter, a method according to various embodiments of the present disclosure will be described in detail.

The electronic device 100 may further include components which have not been mentioned above, such as an ear jack, a proximity sensor, an illumination sensor, a Subscriber Identification Module (SIM) card, a camera, and the like. Further, the electronic device 100 may further include an interface unit for a wired connection with an external device. The interface unit may be connected to the external device through a wire (e.g., a USB cable). Then, the controller 170 may perform data communication with the external device through the interface unit.

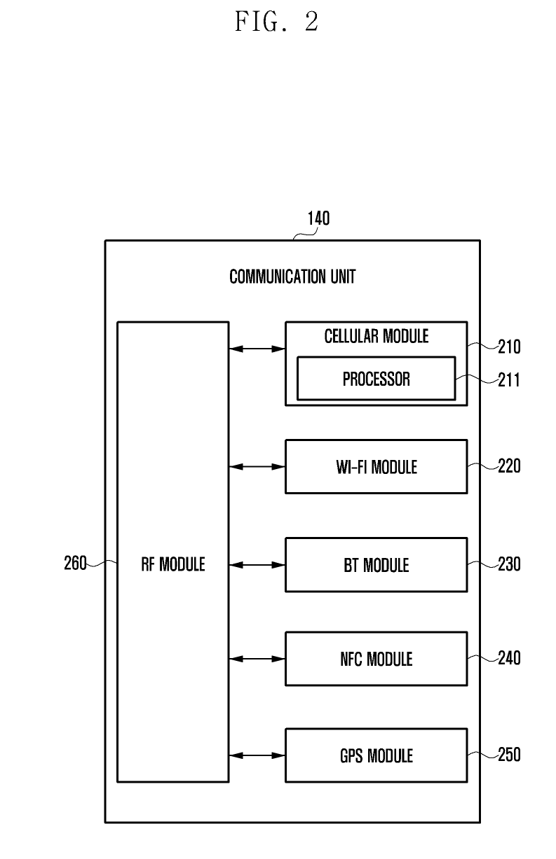

FIG. 2 is a block diagram illustrating a configuration of the communication unit according to various embodiments. Referring to FIG. 2, the communication unit or module 140 may include a cellular module 210, a Wi-Fi module 220, a BT module 230, a NFC module 240, a GPS module 250, and a Radio Frequency (RF) module 260.

The cellular module 210 may perform data communication through a mobile communication network (e.g., LTE, LTE-A, CDMA, WCDMA, UMTS, WiBro, GSM, or the like). The cellular module 210 may authenticate the electronic device 100 by using, for example, a subscriber identification module (e.g., a SIM card).

The cellular module 210 may include a processor 211 (e.g., a CP). The processor 211 may perform at least some of the functions (e.g., at least some of the multimedia control functions) provided by the processor 171. Further, the processor 211 may perform security processing of data by using the security processing module (e.g., the security processing module 133) corresponding to the negotiated layer. Although the processor 211 is illustrated as an internal component of the cellular module 210, the processor 211 may be configured in the electronic device 100 separately from the cellular module 210 according to an embodiment.

The cellular module 210 may be implemented by, for example, an SoC. Although the components such as the cellular module 210 and the storage unit 130 are illustrated as components separated from the processor 171, the processor 171 may include at least some (e.g., the CP) of the above described components according to an embodiment.

The cellular module 210 may load commands or data received from a connected non-volatile memory or at least one other component to a volatile memory and process the loaded commands or data. Further, the cellular module 210 may store data received from or generated by at least one of other component in a non-volatile memory.

Each of the Wi-Fi module 220, the BT module 230, the NFC module 240, and the GPS module 250 may include, for example, a processor for processing data transmitted/received through the corresponding module. Alternatively, the processor 211 or the processor 171 may serve to process the data transmitted/received through the modules.

Although the cellular module 210, the Wi-Fi module 220, the BT module 230, the NFC module 240, and the GPS module 250 are illustrated as separate blocks in FIG. 2, at least some (e.g., two or more) of the cellular module 210, the Wi-Fi module 220, the BT module 230, the NFC module 240, and the GPS module 250 may be included in one Integrated Chip (“IC”) or one IC package according to an embodiment. For example, at least some (e.g., a communication processor corresponding to the cellular module 210 and a Wi-Fi processor corresponding to the Wi-Fi module 220) of the processors corresponding to the cellular module 210, the Wi-Fi module 220, the BT module 230, the NFC module 240, and the GPS module 250 may be implemented as one SoC.

The RF module 260 may transmit/receive data, for example, RF signals. Although not illustrated, the RF module 260 may include, for example, a transceiver, a Power Amp Module (“PAM”), a frequency filter, a low noise amplifier (“LNA”), or the like.

The RF module 260 may further include an element for transmitting/receiving electronic waves over free air space in wireless communication, such as, a conductor, a conducting wire, or the like. Although the cellular module 210, the Wi-Fi module 220, the BT module 230, the NFC module 240, and the GPS module 250 may share one RF module 260 in FIG. 2, at least one of the cellular module 210, the Wi-Fi module 220, the BT module 230, the NFC module 240, or the GPS module 250 may transmit/receive an RF signal through a separate RF module according to an embodiment.

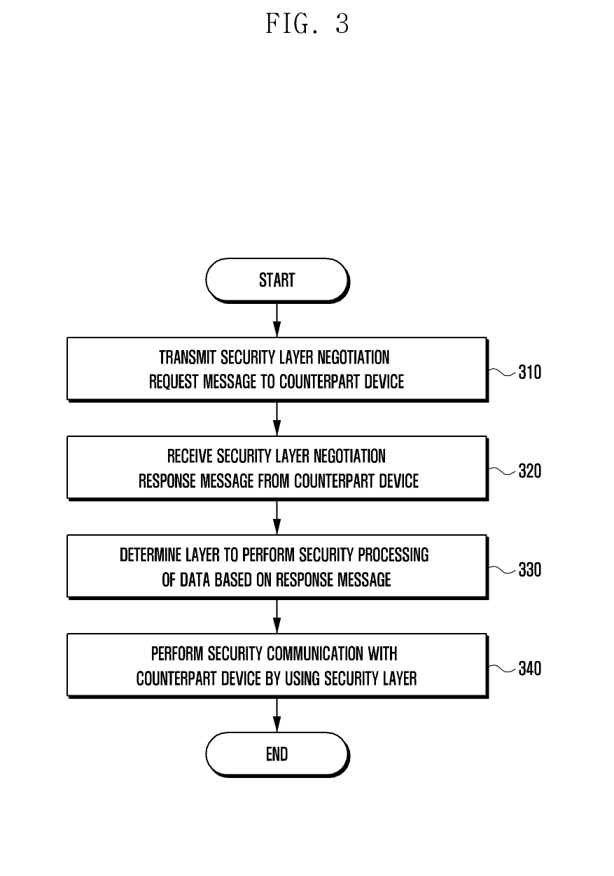

FIG. 3 is a flowchart illustrating a communication method according to an embodiment of the present disclosure.

Referring to FIG. 3, in operation 310, the processor (for example, the processor 171 or 211) of the electronic device 100 may control the communication unit 140 (e.g., the cellular module 210 or the Wi-Fi module 220) to transmit a request message for negotiating for a secure connection to a counterpart device. In operation 320, the processor may receive a response message from the counterpart device through the communication unit 140.

According to an embodiment, when information indicating one or more layers of the electronic device 100 supporting security processing is included in the request message, the response message may include information indicating that the counterpart device selects one of the one or more layers as the security layer.

According to another embodiment, the request message may include information indicating an inquiry (e.g., a request) about a layer of the counterpart device supporting the security processing. Accordingly, the response message may include information indicating at least one layer of the counterpart device supporting the security processing.

According to another embodiment, the request message may include information indicating the content which makes a request for setting a particular layer as the security layer. Accordingly, the response message may include information indicating an acceptance of the request.

In operation 330, the processor of the electronic device 100 may determine at least one of the layers of the electronic device 100 as the security layer based on the response message. Accordingly, the determined layer may be the same as the security layer of the counterpart device through the negotiation process.

According to an embodiment, the processor of the electronic device 100 may identify the response message to recognize which layer of the counterpart device is selected as the security layer and determine the selected layer as the security layer.

According to another embodiment, the processor of the electronic device 100 may identify the response message to recognize which layer of the counterpart device supports the security processing and determine the recognized layer as the security layer. Additionally, the processor of the electronic device 100 may control the communication unit 140 to transmit a confirmation message for informing that the security layer is determined to the counterpart device. In response to the confirmation message, the counterpart device may determine the same as the layer determined by the electronic device 100 to be the security layer.

According to another embodiment, the processor of the electronic device 100 may identify the response message to recognize that the counterpart device accepts the “request for setting the particular layer as the security layer from the electronic device 100” and determine the particular layer as the security layer.

In operation 340, the processor of the electronic device 100 may engage in secure communication with the counterpart device by using the designated security layer. For example, the processor may perform security processing of data by using the security processing module corresponding to the security layer and control the communication unit 140 to transmit the security-processed data to the counterpart device. The processor may decipher (e.g., decode encoded data) the security-processed data, which is received from the counterpart device, by using the security processing module corresponding to the security layer.

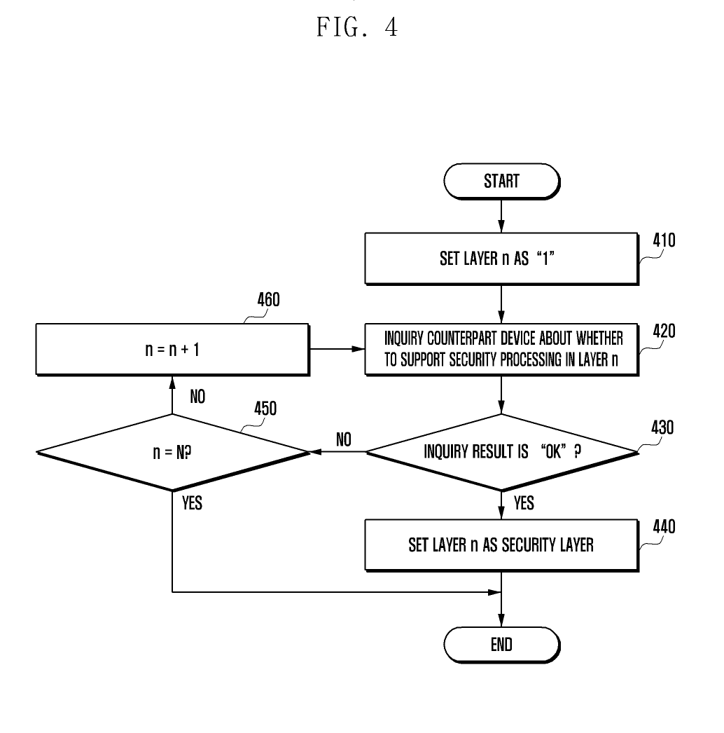

FIG. 4 is a flowchart illustrating a method of dynamically setting a security layer according to an embodiment of the present disclosure.

Referring to FIG. 4, in operation 410, the processor (for example, the processor 171 or 211) of the electronic device 100 may set a probing layer “n” as “1”. That is, the processor may set or select a first layer as a candidate of the security layer. According to an embodiment, in OSI seven-layer structure, an application layer, a presentation layer, a transport layer, and a network layer may support security processing. Of course, the present disclosure is not limited thereto, and another layer may support the security processing.

As the layers may be hierarchically structured, data security in a lower layer may be stronger relative to a higher layer. This is because metadata (e.g., a network port or phone number) as well as application data is security-processed in the lower layer. In such circumstances, among the layers supporting the security processing, a lowest layer may be first selected as the candidate. That is, the first layer may refer to the lowest layer (e.g., network layer) among the layers supporting the security processing.

In operation 420, the processor of the electronic device 100 may inquire the counterpart device about whether the probing layer n supports the security processing. For example, an application layer (e.g., an application for data communication) of the electronic device 100 may generate a security layer negotiation request message including information (e.g., number “n”) on the layer “n” set as the candidate. The communication unit 140 (e.g., the cellular module 210 or the Wi-Fi module 220) may transmit the security layer negotiation request message to the counterpart device in response to a command of the processor.

In operation 430, the processor of the electronic device 100 may receive a result of the inquiry (e.g., a security layer negotiation response message) from the counterpart device through the communication unit 140 and identify the received result of the inquiry. When the inquiry result corresponds to probing success (e.g., information indicating that the security processing can be performed in the layer “n” is included in the response message), the processor of the electronic device 100 may set the probing layer n as the security layer in operation 440.

When the inquiry result corresponds to probing fail (e.g., information indicating that the security processing cannot be performed in the layer “n” is included in the response message), the processor of the electronic device 100 may identify whether n is a maximum value “N” in operation 450. For example, according to the OSI seven-layer structure, the maximum value N may be “7”. That is, in operation 450, the processor of the electronic device 100 may determine whether the negotiation with the counterpart device for all candidates has been made. When n is the maximum value N (i.e., synchronization of the security layer or, matching of the security layer between devices) is not possible even though the negotiation with the counterpart for all candidates has been made, the processor of the electronic device 100 may determine that security communication with the counterpart device is not possible.

When n is not the maximum value N, the processor of the electronic device 100 may reset the next ordered layer “n+1” as the layer “n” in operation 460. That is, the processor may reset the layer, which is one level higher than the previously set layer, as the candidate of the security layer. After resetting the candidate, the processor may repeatedly perform operations 420 and 430.

According to the embodiment described with reference to FIG. 4, the electronic device may make an inquiry to the counterpart device about whether to support the security processing in an ascending order from a lower layer. Accordingly, among the layers which can be synchronized, the lowest layer may be set as the security layer.

According to some embodiments, operation 410 may be an operation for setting a highest layer as the candidate. Then, “N” refers to a minimum value (that is, number indicating a lowest layer) in operation 450, and operation 460 may be an operation for resetting a layer, which is one level lower than the previously set layer, as the candidate of the security layer.

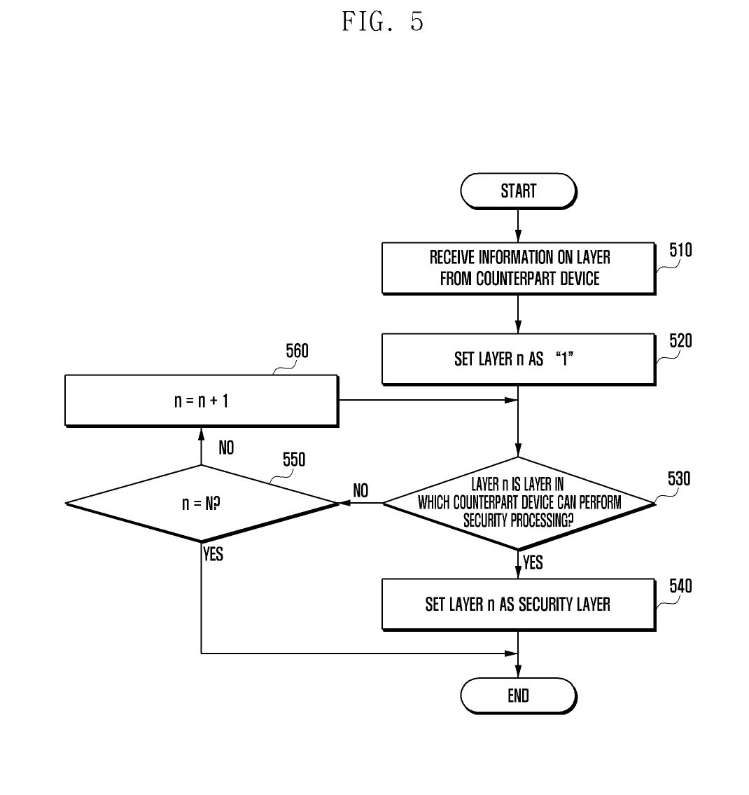

FIG. 5 is a flowchart illustrating a method of dynamically setting a security layer according to another embodiment of the present disclosure.

Referring to FIG. 5, in operation 510, the processor (e.g., the processor 171 or 211) of the electronic device 100 may receive information related to at least one layer from the counterpart device through the communication unit 140 (e.g., the cellular module 210 or the Wi-Fi module 220). For another viewpoint, the counterpart device may transmit a security layer negotiation request message to the electronic device 100. For example, a highest layer (e.g., an application layer) of the counterpart device may generate a security layer negotiation request message including header information on a layer (or a plurality of layers) supporting security processing. The communication unit (e.g., the cellular module or the Wi-Fi module) of the counterpart device may transmit the security layer negotiation request message to the electronic device 100 in response to a command of the processor of the counterpart device.

In operation 520, the processor of the electronic device 100 may set a layer “n” to be compared as “1”. That is, the processor may set or select a first layer as a target to be compared with a layer notified to enable the security processing to the electronic device 100 by the counterpart device. The first layer may refer to a lowest layer (e.g., a network layer) among the layers supporting the security processing.

In operation 530, the processor of the electronic device 100 may determine whether layer n to be compared is the layer in which the counterpart device can perform security processing. For example, the processor may identify header information on the layer from the request message and compare the identified header information (i.e., header information received from the counterpart device) with header information on the set layer n to be compared.

When the layer n to be compared is the layer in which the counterpart device can perform the security processing (e.g., when two pieces of header information match based on a result of the comparison), the processor of the electronic device 100 may set the layer n to be compared as the security layer in operation 540. Further, the processor may transmit a security layer negotiation response message including information on the security layer to the counterpart device through the communication unit 140.

When the layer n to be compared is not the layer in which the counterpart device can perform the security processing (e.g., when two pieces of header information do not match based on a result of the comparison), the processor of the electronic device 100 may identify whether n is the maximum value “N” in operation 550. For example, according to the OSI seven-layer structure, the maximum value N may be “7”.

That is, in operation 550, the processor of the electronic device 100 may determine whether all layers, in which the electronic device 100 can perform security processing, have been compared with the “layer notified to enable the security processing to the electronic device 100 by the counterpart device”. When n is the maximum value N (i.e., all layers are determined to not match the layer notified by the counterpart), the processor of the electronic device 100 may determine that security communication with the counterpart device is not possible.

When n is not the maximum value N, the processor of the electronic device 100 may reset the next ordered layer “n+1” as the layer “n” in operation 560. That is, the processor may reset the layer, which is one level higher than the previously set layer, as the layer to be compared. After resetting the target to be compared, the processor may repeatedly perform operations 420 and 430.

According to the embodiment described with reference to FIG. 5, the devices may synchronize the security layers through one exchange of the request message and the response message. Further, among the layers which can be synchronized, the lowest layer may be set as the security layer. For example, when the layers notified to the electronic device by the counterpart device is a second layer and a third layer, the electronic device may set the second layer as the security layer because the layers are compared with the notified layer in an ascending order from the lower layer.

According to some embodiments, operation 520 may be an operation for setting a highest layer as the target to be compared. Then, “N” refers to a minimum value (i.e., number indicating a lowest layer) in operation 550, and operation 560 may be an operation for resetting a layer, which is one level lower than the previously set layer, as the target to be compared.

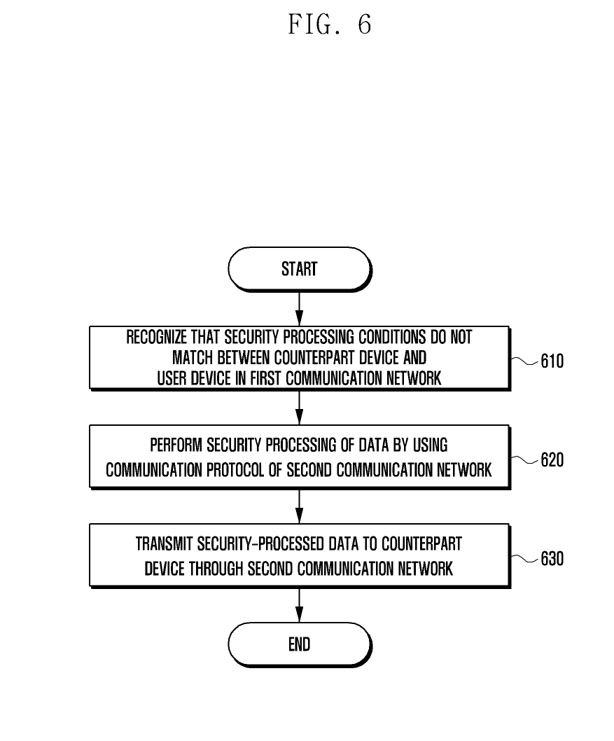

FIG. 6 is a flowchart illustrating a communication method according to another embodiment of the present disclosure.

Referring to FIG. 6, in operation 610, the processor of the user device (e.g., the electronic device 100) may recognize that security processing conditions do not match between the counterpart device and the user device in a first communication network (e.g., 4G or LTE network). For example, when n is the maximum value N in the embodiment described with reference to FIG. 4 or 5, the processor may recognize that security communication is not possible in the first communication network (i.e., security layers do not match between the devices). As the security communication is not possible, the user device may determine to switch the network to a second communication network (e.g., a 3G or CDMA network). In operation 620, the processor of the user device may perform security processing of data by using a communication protocol of the second communication network. In operation 630, the processor of the user device may control the communication unit (e.g., the cellular module 210) to transmit the security-processed data to the counterpart device through the second communication network.

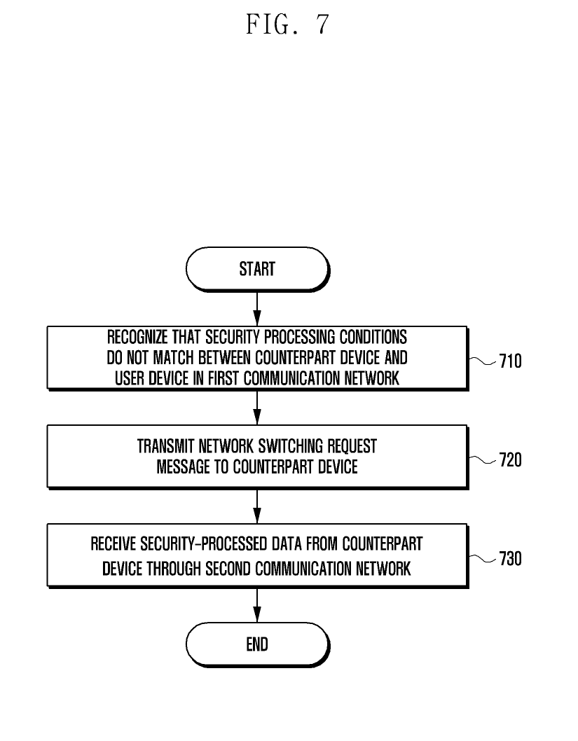

FIG. 7 is a flowchart illustrating a communication method according to another embodiment of the present disclosure.

Referring to FIG. 7, in operation 710, the processor of the user device (e.g., the electronic device 100) may recognize that security processing conditions do not match between the counterpart device and the user device in a first communication network. As the security processing conditions do not match, the user device may determine to switch the network to a second communication network (e.g., 3G CDMA). In operation 720, the processor of the user device may control the communication unit (e.g., the cellular module 210) to transmit a network switching request message to the counterpart device through the first communication network (or the second communication network). In operation 730, the communication unit of the user device may receive the security-processed data from the counterpart device through the second communication network and transfer the received security-processed data to the processor.

The “module” used in various embodiments of the present disclosure may refer to, for example, a “unit” including one of hardware, software, and firmware, or a combination of two or more of the hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to various embodiments of the present disclosure may include at least one of an Application-Specific Integrated Circuit (ASIC) chip, a Field-Programmable Gate Arrays (FPGAs), and a programmable-logic device for performing operations which have been known or are to be developed hereafter.

According to various embodiments, at least some of the devices (for example, modules or functions thereof) or the method (for example, operations) according to the present disclosure may be implemented by a command stored in a computer-readable storage medium in a programming module form. When the command is executed by processors, the processors may perform a function corresponding to the command. The computer-readable storage media may be, for example, the memory (e.g., the storage unit 130). At least a part of the programming module may be implemented (e.g., executed) by a processor. At least some of the programming modules may include, for example, a module, a program, a routine, a set of instructions or a process for performing one or more functions.

The computer readable recording medium may include magnetic media such as a hard disc, a floppy disc, and a magnetic tape, optical media such as a compact disc read only memory (CD-ROM) and a digital versatile disc (DVD), magneto-optical media such as a floptical disk, and hardware devices specifically configured to store and execute program commands, such as a read only memory (ROM), a random access memory (RAM), and a flash memory. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

A module or a programming module according to the present disclosure may include at least one of the described component elements, a few of the component elements may be omitted, or additional component elements may be included. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Embodiments of the present disclosure provided in the present specifications and drawings are merely certain examples to readily describe the technology associated with embodiments of the present disclosure and to help understanding of the embodiments of the present disclosure, but may not limit the embodiments of the present disclosure. Therefore, in addition to the embodiments disclosed herein, the various embodiments of the present disclosure should be construed to include all modifications or modified forms drawn based on the technical idea of the various embodiments of the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. A method of communicating data by an electronic device, the method comprising:
negotiating with a counterpart device for a security layer to perform security processing of data;
determining at least one layer as the security layer based on the negotiation outcome; and
communicating with the counterpart device using the security layer.

2. The method of claim 1, wherein the negotiating comprises:
setting one layer of a plurality of security layers as a candidate for the security layer,
transmitting information on the candidate to the counterpart device, and
receiving information from the counterpart device indicating whether to select the candidate as the security layer, and
wherein the determining the at least one layer as the security layer comprises determining the candidate selected by the counterpart device as the security layer according to the received information.

3. The method of claim 2, wherein the plurality of security layers is hierarchical, and a lowest layer of the plurality of security layers is first set as the candidate.

4. The method of claim 2, wherein the layer set as the candidate performs security processing of application data and metadata related to the application data.

5. The method of claim 1, wherein the negotiating comprises:
receiving information on a plurality of security layers from the counterpart device;
selecting one of the plurality of security layers corresponding to the information; and
transmitting information on the selected one of the plurality of layers to the counterpart device,
wherein the determining of the at least one layer comprises determining the selected one of the plurality of layers as the security layer.

6. The method of claim 5, wherein a lowest layer is determined as the security layer from among the plurality of security layers corresponding to the received information on the plurality of security layers.

7. The method of claim 1, further comprising:
when the negotiation outcome indicates no security layer matches between the electronic device and the counterpart device in a first communication network, communicating with the counterpart device through a second communication network.

8. An electronic device comprising:
a communication unit for communicating with a counterpart device through a communication network; and
at least one processor configured to:
negotiate via the communication unit with the counterpart device for a security layer to perform security processing of data;
determine at least one layer as the security layer based on the negotiation outcome; and
communicate with the counterpart device using the security layer.

9. The electronic device of claim 8, wherein the at least one processor comprises at least one of an application processor and a communication processor.

10. The electronic device of claim 8, wherein the communication unit includes a cellular module configured to communicate with the counterpart device through a first mobile communication network.

11. The electronic device of claim 10, wherein the at least one processor is further configured to:
communicate with the counterpart device through a second mobile communication network rather than the first mobile communication network when the negotiation outcome indicates that no security layer matches between the electronic device and the counterpart device between the electronic device and the counterpart device in the first mobile communication network

12. The electronic device of claim 8, wherein the at least one processor is further configured to:
set one layer of a plurality of security layers as a candidate for the security layer;
transmits information on the candidate to the counterpart device through the communication unit; and
receive information from the counterpart device indicating whether to select the candidate as the security layer,
wherein the determining the at least one layer as the security layer comprises determining the candidate selected by the counterpart device as the security layer according to the received information.

13. The electronic device of claim 8, wherein the processor receives information on at least one layer from the counterpart device through the communication unit, selects one of the layers corresponding to the information, transmits information on the selected layer to the counterpart device, and determines the selected layer as the security layer.

14. A non-transitory computer-readable recording medium having commands stored therein, the commands are configured to allow one or more processors to perform one or more operations when executed by the one or more processors, the one or more operations comprising:
negotiating with a counterpart device for a security layer to perform security processing of data;
determining at least one of the layers as the security layer based on the negotiation outcome; and
communicating with the counterpart device by using the security layer.
